(19) United States
(12) Patent Application Publication
(10) Pub. No.: US 2025/0148469 A1
(43) Pub. Date: May 8, 2025

(54) DEPOSIT FRAUD DETECTION

(71) Applicant: FMR LLC, Boston, MA (US)

(72) Inventors: ANDREW WIRTHLIN, CINCINNATI, OH (US); JOHN ECONOMIDIS, TROPHY CLUB, TX (US); PRAFUL IYER, LEWISVILLE, TX (US); BRADLEY CARRIER, NASHUA, NH (US)

(21) Appl. No.: 18/386,848

(22) Filed: Nov. 3, 2023

(51) Int. Cl. G06Q 20/40; G06Q 20/10

(52) U.S. Cl. CPC G06Q 20/4016; G06Q 20/10

(57) ABSTRACT

A computerized method is provided for automatic monitoring and detection of deposit fraud. Methods can include receiving, by a computing device, user account information, assessing the user account information to determine a fraud risk score and, if sufficient, adding the account to a watchlist for additional monitoring.

### TECHNICAL FIELD

This application relates generally to systems, methods and apparatuses, including computer program products, for automated risk-based deposit fraud detection.

### BACKGROUND

Historically, fraud detection has been centered around isolated patterns and individual data points, with no process designed to specifically target fraudulent deposits. While these fraudulent deposits could be identified incidentally by these existing processes, many go undetected until the bank or entity from which the deposit was drawn notifies the recipient entity and re-claims the deposit. In many instances, the deposited funds will have already been withdrawn from the account, resulting in a loss to the recipient company. The last several years have brought consistent increases in losses due to such fraudulent deposits.

### SUMMARY

Systems and methods described herein provide a dynamic process dedicated to identifying potentially fraudulent deposits. Through automatic analysis of user, account, and deposit information, the aforementioned problem of accounts being funded with undetected fraudulent deposits can be addressed, Systems and methods herein apply a multifaceted approach which involves targeting the highest risk population for deposit fraud, new customers, and leveraging multiple data points including internal data and information and/or risk assessments sourced from third parties.

In certain embodiments, upon opening a new account, the user will enter personal information that can then be assessed to assign a risk score indicating the risk that deposits from the user's account may be fraudulent, That assessment can, for example, be performed internally or with the use of a third-party tool. The risk score can compare user-submitted information to publicly available information and/or characteristics associated with fraudulent accounts. Customers with a risk score above a certain threshold can be deemed high-risk and added to a watchlist for a specified number of days. During this period, the user account can be monitored to gain additional data points that can be indicative of a higher risk score.

If a predetermined number of data points indicative of potential fraud are identified, an alert can be generated. These data points can be obtained from existing products such as ThreatMetrix available from RELX plc and products available from Early Warning Services, LLC, as well as internal data points from observing transactional and customer profiles and changes therein. Examples of such data points can include high risk logins, the addition of outgoing payment instructions, and changes to customer contact information.

By taking a layered approach to identify new customers with an elevated risk and capturing data points from several sources, suspicious deposits can be detected and flagged. Those deposits can then be rejected, held pending confirmation of legitimacy, and/or manually reviewed by a fraud analyst.

Aspects of the invention can include a computerized method for identifying a fraudulent electronic funds transfer (EFT), with the method comprising steps of receiving, at a computing device, user account information for an account depositing funds using EFT and evaluating the user account information to assign a risk score to the user account. Methods can include then determining that the risk score for the user account is greater than a threshold risk score, adding the user account to a watchlist database for fraud detection, calculating a number of infractions for the added user account and, when the number of infractions is greater than a selected infraction threshold, marking the deposit for further review. Calculating the number of infractions can include one or more of analyzing the user account information for a number of authentication infractions, analyzing user deposit records for suspicious activity, analyzing disbursement records for suspicious activity, analyzing user account for suspicious activity, analyzing user deposit records for deposits in bad order, and importing one or more third-party fraud risk scores.

In certain embodiments, calculating the number of infractions can include assigning a weight to each of the infractions. Assigning a risk score to the user account can include validating user-provided information submitted in an account application against independently obtained user information. The authentication infractions can comprise mismatches between user-provided information and corresponding independently obtained user information. Analyzing the user deposit records for suspicious activity can include one or more of identifying past returned checks and identifying failed deposits. In some embodiments, analyzing disbursement records for suspicious activity can include one or more of identifying recent changes in outgoing payment instructions for the user, and identifying disbursements occurring in close proximity to deposits.

Analyzing the user account for suspicious activity can comprise identifying one or more of recent changes in user account information, recent changes in user contact information, invalid contact information, failed login attempts, changes to login methods, recent high-risk logins by user, geographic location of user contact information in a high risk area, geographic location of a user login in a high risk area, differences between geographical location of user contact information, and geographical location of user login. Methods can further comprise altering a number of processing threads used for evaluating the user account information or calculating the number of infractions based on one or more of a number of new use accounts to evaluate and a total number of user accounts in the watchlist database.

In some embodiments, methods can include setting parameters for the evaluating and calculating steps comprising one or more of entering the threshold risk score, entering a time-out period for removing a user account from the watchlist database, entering a threshold deposit amount required before marking the deposit for further review, entering a path to direct deposits for further review, and entering the selected infraction threshold. The calculating step can be automatically repeated periodically for each user account in the watchlist database. The calculating step may be automatically repeated at least once per hour for each user account in the watchlist database.

In certain embodiments, methods can comprise removing the user account from the watchlist database where the number of infractions for the added user account is below a monitoring threshold, Methods may include removing the user account from the watchlist database after a selected period of user inactivity. Marking for further review can include sending one or more of the user account information, the assigned risk score, and the calculated number of infractions to an analyst for manual review. In some embodiments, marking for further review can comprise prompting the user for additional information.

In certain aspects systems for identifying a fraudulent electronic funds transfer (EFT) are described. Systems can comprise a server computing device comprising a processor and a memory storing instructions that, when executed by the processor, cause the processor to perform the steps of: receiving, at a computing device, user account information for an account depositing funds using EFT; evaluating the user account information to assign a risk score to the user account; determining that the risk score is greater than a threshold risk score; adding the user account to a watchlist database for fraud detection; calculating a number of infractions for the added user account and, where the number of infractions is greater than a selected infraction threshold, marking the deposit for further review, wherein calculating the number of infractions includes one or more of analyzing the user account information for a number of authentication infractions, analyzing user deposit records for suspicious activity, analyzing disbursement records for suspicious activity, analyzing user account for suspicious activity, analyzing user deposit records for deposits in bad order, and importing one or more third-party fraud risk scores.

In various embodiments systems of the invention can be operable to perform any and all of the aforementioned methods.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows an exemplary computerized method for identifying a fraudulent EFT transaction.

FIG. 2 shows an exemplary flow chart for a computerized method of identifying a fraudulent EFT.

FIG. 3 shows an exemplary DFE communication network facilitated by Kafka Services to pull information from various sources in order to assess fraud risk.

FIG. 4 shows an exemplary user interface for manual review of flagged deposits.

### DETAILED DESCRIPTION

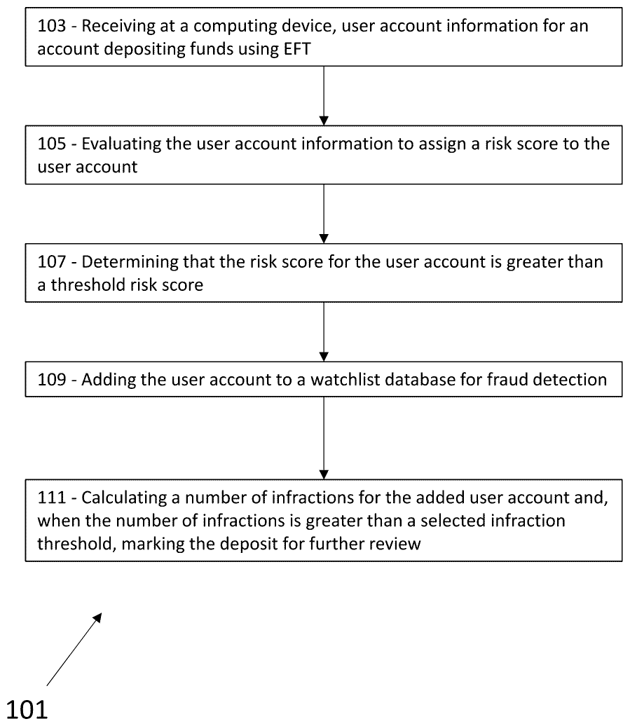

FIG. 1 shows an exemplary method 101 for identifying a fraudulent electronic funds transfer (EFT). User account information for an account depositing funds using EFT is received 103 at a computing device. Exemplary computing devices are described below but include any physical or virtual device or group of networked devices comprising memory for storing instructions and a processor for executing those instructions. In certain embodiments, a user may open an account through a web site or mobile application by entering user information using their computer or mobile device, That information can include personal identifying information such as name, address, birth date, social security number, phone number, employment information, income information, and/or financial information such as banking details.

The user account information can then be evaluated 105 to assign a risk score to the user account. This evaluation can include the use of existing identity verification or other security tools such as those available from Socure, Inc., RELX plc or Early Warning Services, LLC. Evaluation 105 can include obtaining user information from sources independent from the account application. For instance, publicly available resources such as public social media profiles, address records, employer websites, or deed registries can be searched and the resulting information can be compared to that submitted by the user in their application to verify the user's claimed identity. In some embodiments, a privately compiled or commercial database of information may be used as an independent source of user data for validation. Based on the comparison, a risk score can be assigned where inconsistencies between the user-submitted information and the independently sourced user information are indicative of a higher risk. In some embodiments, a lack of independent-sourced user information can also result in a higher risk score. Evaluation 105 can be automatically initiated for all new accounts as they are opened and/or may be periodically performed on existing accounts.

A threshold risk score can be established to indicate when a user is likely to be legitimate or may warrant additional scrutiny as a fraud risk. The computing device, upon obtaining a risk score for the user, can determine 107 that the risk score is above the preset threshold and, therefore flag the account for additional scrutiny. In some embodiments, that additional scrutiny may include adding 109 the user account to a watchlist database for increased fraud risk wherein deposits made by the accounts in the watchlist database can be subject to additional analysis.

For deposits made by accounts in the watchlist database, the computing device can calculate 111 a number of infractions for the added user account and, when the number of infractions is greater than a selected infraction threshold, mark the deposit for further review. Infractions can include any account, user, or deposit characteristic that is indicative of an increased fraud risk. Calculating the number of infractions can include one or more of analyzing the user account information for a number of authentication infractions, analyzing user deposit records for suspicious activity, analyzing disbursement records for suspicious activity, analyzing user account for suspicious activity, analyzing user deposit records for deposits in bad order, and importing one or more third-party fraud risk scores such as those discussed above (Socure, Inc., RELX plc or Early Warning Services, LLC.). Authentication infractions may include mismatches between user-submitted information and independently sourced user information wherein each mismatch can be counted as an infraction.

User deposit records can be analyzed for suspicious activity which may include prior instances of returned checks or failed deposits. Such occurrences may have occurred with the financial institution receiving the deposit and therefore be stored in their records along with the user profile or may have occurred elsewhere and can be obtained from third-parties such as credit scoring agencies. Suspicious deposit activity may include deposits in bad order, such as attempted deposits that were not necessarily fraudulent but did not meet company policy requirements and were therefore rejected. For example, a company may not permit a money order deposit, Prior attempts to fund a deposit using a money order can be stored and tracked for auditing purposes and counted as an infraction indicative of future fraud risk.

Disbursement records can be analyzed for suspicious activity which may include identifying recent changes in outgoing payment instructions for the user or identifying disbursements occurring in close proximity to deposits. Recent updates to EFT, bank wire, or digital payment instructions may be suspicious. Additionally certain types of disbursement methods may be inherently more indicative of fraud risk regardless of recent updates.

Suspicious user account activity can include recent changes in user account information, recent changes in user contact information, invalid contact information, failed login attempts, changes to login methods (including two-factor authentication methods), signature forgeries, recent high-risk logins by user, geographic location of user contact information in a high-risk area, geographic location of a user login in a high risk area, differences between geographical location of user contact information, and geographical location of user login.

In various embodiments, one infraction may be more indicative or fraud risk than another. For example, a prior failed deposit or returned check may be more indicative of future fraud than a recent address change. Accordingly, infractions can be weighted so that more serious infractions are counted more than less serious infractions when determining whether to mark an account or deposit for further review.

In certain embodiments, the type of deposit being made (e.g., EFT or check) can be used at the outset to automatically trigger a different set of analysis parameters. For example, the aforementioned threshold risk score or infraction threshold can differ depending on the type of deposit as one type of deposit (e.g., check vs. EFT) may be more inherently at risk of fraud. In some embodiments, a different set of infractions or data can be used in determining fraud risk based on the type of deposit.

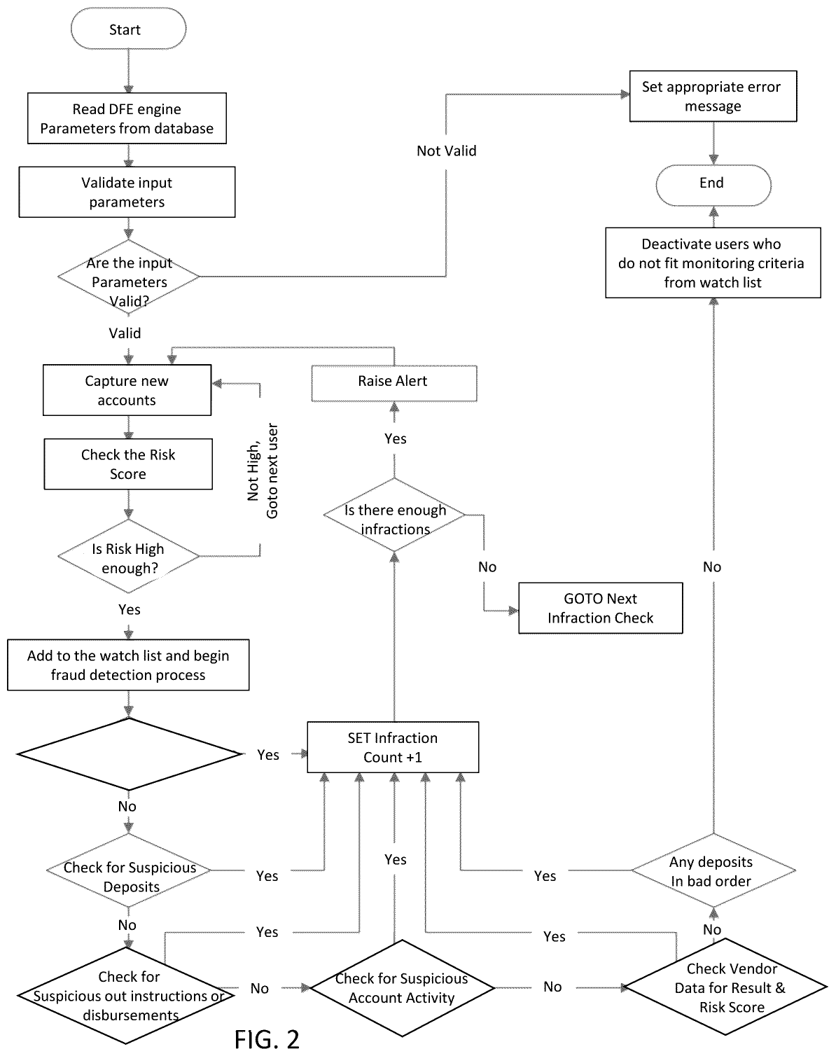

FIG. 2 shows an exemplary flow chart for monitoring accounts and deposits for potential fraud. The steps shown can be performed using and deposit fraud engine (DFE) and database that may be accessed upon receipt of new client account information from a client computing device. The client computing device can connect through a communication network to communicate with the DFE and/or the database to provide inputs and receive outputs relating to the client account and any deposit information. The communication network allows components of the computing system to communicate with each other to perform the method steps discussed above for detecting deposit fraud. The network may be a local network, such as a LAN, or a wide area network, such as the Internet and/or a cellular network. In some embodiments, the network is comprised of several discrete networks and/or sub-networks (e.g., cellular to Internet) that enable the components of the system to communicate with each other.

The DFE can be a combination of hardware, including one or more processors and one or more physical memory modules and specialized software engines that execute on the processor of the DFE, to receive data from other components of the computing system, transmit data to other components of the computing system, and perform functions as described herein.

In certain embodiments, the DEE can use a variety of information provided from other servers and databases, some at real-time, others historical. The DFE can communicate with various data sources including cloud based and mainframe server-based systems using services such as Snowflake (Snowflake Inc.), AWS (Amazon Web Services), Oracle, Unix scripting, and Apache Kafka. These communications can be secured with multiple firewalls and access level restrictions as well as encryption to ensure data privacy. The DFE Engine may be hosted on a server that is scalable at both software as well as hardware level, wherein the parameters of the system can be changed to accommodate additional computational power when needed thus improving the throughput of the system to raise alerts. A Kafka engine can be used to read data through multiple sources and then load them into the DFE database to be consumed. That data can consist of millions of rows of data during any given day that the DFE engine processes to determine any potentially fraudulent activity.

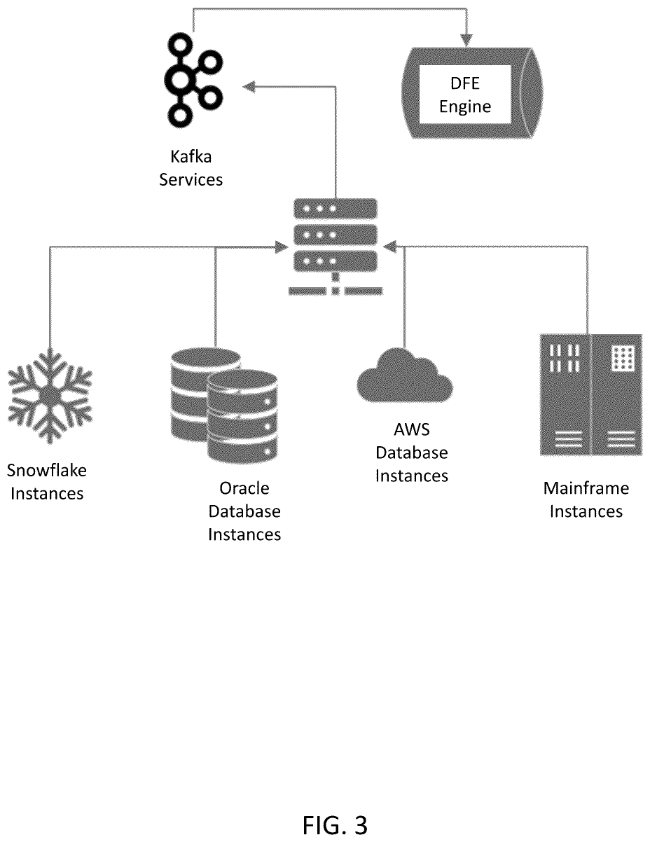

The information used to assess fraud risk such as user account information, user deposit records, disbursement records, user information, and third-party risk scores can be stored in a variety of locations and formats. Accordingly, systems and methods described herein can communicate with each disparate data source in order to provide the required information to the DFE engine for processing. FIG. 3 illustrates an exemplary DFE engine wherein an event streaming platform such as Apache Kafka is used to continuously direct data from various sources such as snowflake instances, oracle database instances, AWS database instances, and mainframe server database instances to the DFE engine for processing fraud risk.

The database is a computing device (or in some embodiments, a set of computing devices) that is coupled to and in communication with the DFE and is configured to provide, receive and store various types of data received and/or created for performing the fraud detection steps as described herein. In some embodiments, all or a portion of the database may be integrated with the DFE or located on a separate computing device or devices. For example, the database can comprise one or more databases, such as MySQL™ available from Oracle Corp. of Redwood City, California.

One advantage of the Deposit Fraud Engine is that all parameters can be stored in the database and can be configured at run time depending on the load. For example, when the DFE detects a high volume to process (e.g., a large number of new user applications and/or deposits), it can split between 1 and ‘n’ parallel threads to reduce the load on each thread and still be able to process large volume of data. That process can include monitoring overall system load as well as DFE-specific load. Both the number of new applications to be processed as well as the current number of accounts in the watchlist database may be accounted for in determining the number of processing threads the DFE should use.

In some embodiments, at the onset, the engine will validate input parameters and if not valid will exit with an appropriate message relaying the invalidity. Assuming the input parameters are valid, the engine will detect any new customers that have an elevated risk score and add them to the watch list. What risk score value is considered high is again stored in the database and configurable. Once these accounts are on the watch list, the engine will periodically keep checking transactions across the business for further infractions. User accounts may remain on the watch list until they no longer fit the monitoring criteria or after a preset amount of time with no detected fraud.

Returning to FIG. 2, the DFE can access input parameters from the database and validate them. As mentioned, if the input parameters are invalid, the DFE can provide an appropriate error message and end. If the input parameters are correct, the DFE can proceed to capture new accounts. A risk score can be obtained for each new account using, for example, the methods described above. If the risk score is below a threshold, the DFE can move on to the next new account. When a new account is identified with a risk score above the threshold for monitoring, it can be added to the watch list and subjected to a fraud detection process. That process can be automated and occur at regular intervals and/or through manual initiation or trigger events (e.g., receipt of a new deposit, transfer, or withdrawal request).

The fraud detection process can include the DFE checking for a number of authentication infractions from the initial risk score assessment. If that number is above a threshold level, an infraction can be noted on the account, increasing the infraction count before proceeding to the next infraction check. Otherwise, the DFE will move to the next infraction check without increasing the infraction count. The additional infraction checks can include suspicious deposits, suspicious out instructions or disbursements, suspicious account activity, third-party risk scores, and/or deposits in bad order all as discussed in more detail above. If after cycling through the infraction checks, the infraction count is below a fraud risk threshold, the process ends for that account and the next account on the watchlist can be evaluated. If the infraction count drops below a threshold monitoring score, the account may be removed from the watchlist. In some embodiments, accounts may be removed from the watchlist after a set monitoring period with no actual fraud detected.

If, after cycling through the infraction checks, the infraction count is above a fraud risk threshold, an alert can be raised calling for additional steps such as marking the account or deposit for additional review. Additional review may include automatically contacting the user and prompting them for additional identity, account, or deposit verification or other information. In some embodiments, if an infraction count is high enough, additional review may include locking the account in which all transactions originating from the account are cancelled. In certain embodiments, additional review can include sending one or more of the user account information, the assigned risk score, and the calculated number of infractions to an analyst for manual review. The additional review may be dictated by the severity of the infraction count such that different levels above the threshold will result in different actions.

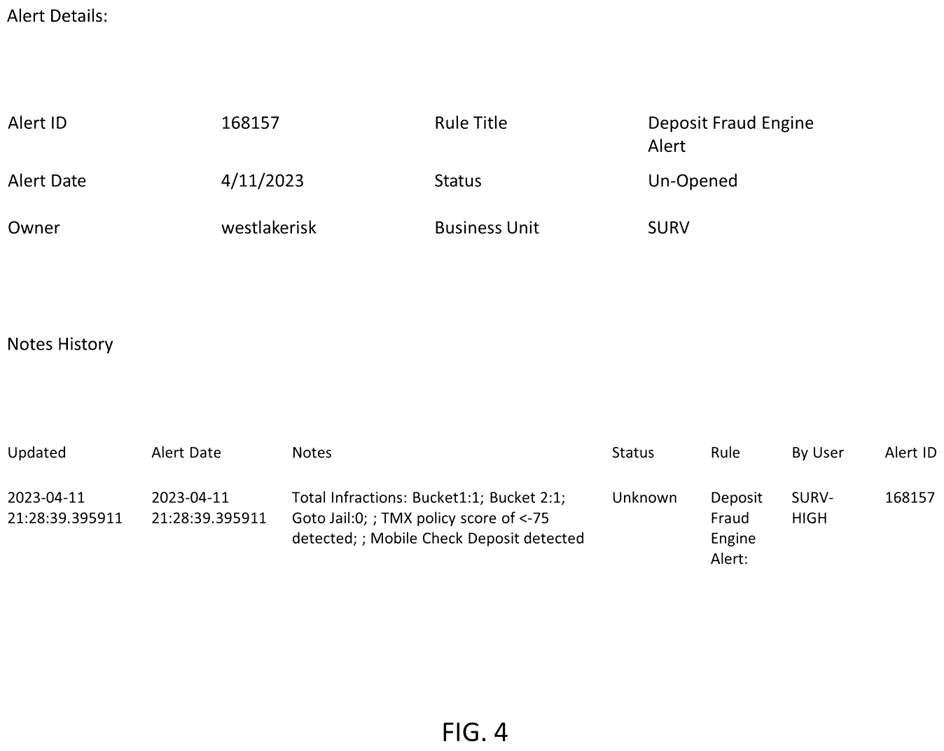

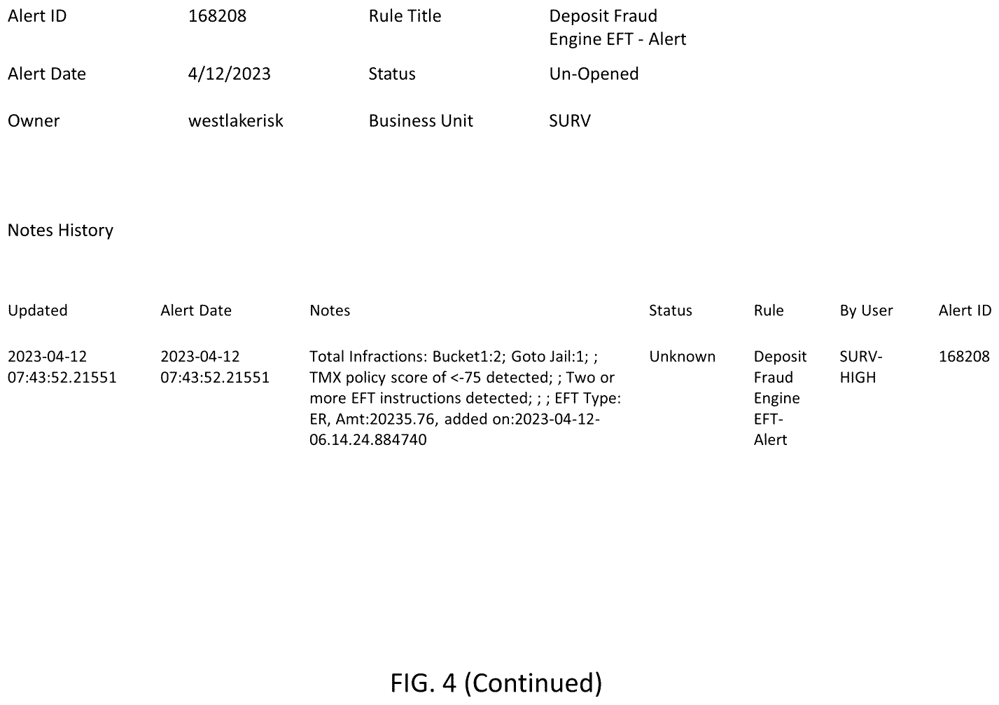

FIG. 4 shows exemplary user interfaces used for manual review of flagged accounts in which the total infractions and a summary of those infractions are provided.

In certain embodiments, the DFE can connect to a variety of databases to fetch real time data to run its infractions. An administrator can set and/or change a number of parameters for the DFE through, for example, a user interface. For example, parameters for the evaluating and calculating steps may be entered such as the threshold risk score, a time-out period for removing a user account from the watchlist database, a threshold deposit amount required before marking the deposit for further review, a path to direct deposits for further review, and the selected infraction threshold.

| | | Sample | |
|---|---|---|---|
| # | Parameter Name | Value | Comments |
| 1. | THREAD_CNT | 10 | Number of Threads to run |
| 2. | NEW_USER_RISK | P | Risk score for new user beyond which a customer will |
| | | | be monitored. |
| 3. | RISK_SCORE2 | −65 | Risk score for vendor 2 beyond which a customer will |
| | | | be inspected. |
| 4. | WL_PERIOD | 10 | Wait list period beyond which a customer will not be |
| | | | inspected. |
| 5. | AMT_CHECK | 100 | $ amount beyond which a user will be monitored to raise |
| | | | alert |
| 6. | ALERT_OWNER | FID_RISK | Internal Fidelity group to which the alert will be raised. |
| 7. | INF_CNT | 2 | Number of infractions needed before alert is raised. |

Table 1 below is an exemplary list of engine parameter values that are configured for the process to run smoothly. When the load is high, the number of threads needed can be changed. Parameters can be consumed on the fly by the DFE.

### Table 1. DFE Parameters Control

Table 2 below is an example of how risk scores can be received from one of the external vendors for new accounts that are opened and their effective date. The risk score can be assigned by the external vendor based on their own methodologies and input as is or, in some embodiments, the underlying attributes used by the vendor to assign a risk score may be received and considered, Scores can be requested and entered for all new accounts as well as periodically for existing accounts.

TABLE 2
Sample Risk score for new customers

| | | Risk | | |
|---|---|---|---|---|
| # | Customer ID | Score | EFF Date | Comments |
| 1. | 5e602e9e87c511e491699bc | F | 2023 Jan. 10 | Risk score if the customer(s) |
| 2. | 62352f620ad01ebc20013df1 | P | 2023 Jan. 12 | during account opening phase |
| 3. | c72c063e2f3711e2b97c9bc8 | N | 2023 Jan. 13 | |
| 4. | ffa8582a9e0b11e3a00b9bc8 | F | 2023 Jan. 13 | |

Table 3 below is a sample data from a vendor more detail on activities performed by the user to determine the risk level.

TABLE 3
Sample Risk score from Vendor

| # | Customer ID | Activity type\hat{ } | Score | Effective Date/Time |
|---|---|---|---|---|
| 1. | 5e602e9e87c511e491699bc | Geo Location not USA | −40 | 2023 Jan. 10 12:14:33 |
| 2. | 62352f620ad01ebc20013df1 | Russian Time zone | −75 | 2023 Jan. 12 02:43:21 |
| 3. | c72c063e2f3711e2b97c9bc8 | None | 0 | 2023 Jan. 13 05:54:32 |
| 4. | ffa8582a9e0b11e3a00b9bc8 | None | 0 | 2023 Jan. 13 06:44:33 |

Table 4 below shows an exemplary watchlist of the engine, where new users are continuously added, and existing ones are actively monitored. This table also acts as a history of what the customer has been doing within the account in case there is any need for the analyst to investigate in more detail at a later stage.

TABLE 4
DFE Watchlist

| | | Effective | Reason | | Infractions | Infractions |
|---|---|---|---|---|---|---|
| # | Customer ID | Date / Time | Added | Comments | Found | Comment\hat{ } |
| 1. | 5e602e9e87c511e491699bc | 2023-01-10 | Risk | Deactivated after | 1 | Bad check |
| | | 12:14:33 | score R | cool-off period | | deposited |
| 2. | 62352f620ad01ebc20013df1 | 2023-01-12 | Risk | | 0 | |
| | | 02:43:21 | score S | | | |
| 3. | c72c063e2f3711e2b97c9bc8 | 2023-01-13 | Risk | Alert generated | 2 | User not in USA; |
| | | 05:54:32 | score T | | | Invalid phone # |
| 4. | ffa8582a9e0b11e3a00b9bc8 | 2023-01-13 | Risk | Alert generated | 2 | User not in USA; |
| | | 06:44:33 | score T | | | Invalid phone # |

Table 5 shows an exemplary alert generated by the DFE which gives details about the customer in question. From this point an analyst can take necessary actions such as looking more deeply into the type of transactions that this customer has been performing or contacting the customer to validate their actions. If fraud is determined, additional steps can be taken to safeguard the account such locking the account or even cancelling any transactions performed and raising a case with law enforcement agencies.

TABLE 5
Sample alert that is generated by the engine:

| # | Name | Value | Comments |
|---|---|---|---|
| 1. | Alert ID | ID123456 | Unique Alert ID |
| 2. | Customer | 5e602e9e87c511e491699bc | Unique customer with Fidelity |
| 3. | Alert Date | 2023 Mar. 12 14:10:24 | Date & time when the “potential” fraud |
| | | | occurred |
| 4. | Group | FID_RISK | Analyst group to which this alert is assigned. |
| 5. | Notes | User has high new account | Details about the alert |
| | | risk score with high amount | |
| | | of money moment | |
| 6. | Source | DFE | Process that generated this alert |
| 7. | Resolution | <BLANK> | If a resolution is provided, then this field will |
| | ID | | be generated. |

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile computing device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile computing device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computerized method for identifying a fraudulent electronic funds transfer (EFT), the method comprising:
receiving, at a computing device, user account information for an account depositing funds using EFT;
evaluating the user account information to assign a risk score to the user account;
determining that the risk score for the user account is greater than a threshold risk score;
adding the user account to a watchlist database for fraud detection;
calculating a number of infractions for the added user account and, when the number of infractions is greater than a selected infraction threshold, marking the deposit for further review,
wherein calculating the number of infractions includes one or more of analyzing the user account information for a number of authentication infractions, analyzing user deposit records for suspicious activity, analyzing disbursement records for suspicious activity, analyzing user account for suspicious activity, analyzing user deposit records for deposits in bad order, and importing one or more third-party fraud risk scores.

2. The computerized method of claim 1, wherein calculating the number of infractions comprises assigning a weight to each of the infractions.

3. The computerized method of claim 1, wherein assigning a risk score to the user account comprises validating user-provided information submitted in an account application against independently obtained user information.

4. The computerized method of claim 1, wherein the authentication infractions comprise mismatches between user-provided information and corresponding independently obtained user information.

5. The computerized method of claim 1, wherein analyzing the user deposit records for suspicious activity comprises one or more of identifying past returned checks and identifying failed deposits.

6. The computerized method of claim 1, wherein analyzing disbursement records for suspicious activity comprises one or more of identifying recent changes in outgoing payment instructions for the user and identifying disbursements occurring in close proximity to deposits.

7. The computerized method of claim 1, wherein analyzing the user account for suspicious activity, comprises identifying one or more of recent changes in user account information, recent changes in user contact information, invalid contact information, failed login attempts, changes to login methods, recent high-risk logins by user, geographic location of user contact information in a high risk area, geographic location of a user login in a high risk area, differences between geographical location of user contact information, and geographical location of user login.

8. The computerized method of claim 1, further comprising altering a number of processing threads used for evaluating the user account information or calculating the number of infractions based on one or more of a number of new use accounts to evaluate and a total number of user accounts in the watchlist database.

9. The computerized method of claim 1, further comprising setting parameters for the evaluating and calculating steps comprising one or more of entering the threshold risk score, entering a time-out period for removing a user account from the watchlist database, entering a threshold deposit amount required before marking the deposit for further review, entering a path to direct deposits for further review, and entering the selected infraction threshold.

10. The computerized method of claim 1, wherein the calculating step is automatically repeated periodically for each user account in the watchlist database.

11. The computerized method of claim 10, wherein the calculating step is automatically repeated at least once per hour for each user account in the watchlist database.

12. The computerized method of claim 10, further comprising removing the user account from the watchlist database where the number of infractions for the added user account is below a monitoring threshold.

13. The computerized method of claim 1, further comprising removing the user account from the watchlist database after a selected period of user inactivity.

14. The computerized method of claim 1, wherein marking for further review comprises sending one or more of the user account information, the assigned risk score, and the calculated number of infractions to an analyst for manual review.

15. The computerized method of claim 1, wherein marking for further review comprises prompting the user for additional information.

16. A system for identifying a fraudulent electronic funds transfer (EFT), the system comprising a server computing device comprising a processor and a memory storing instructions that, when executed by the processor, cause the processor to perform the steps of:
receiving, at a computing device, user account information for an account depositing funds using EFT;
evaluating the user account information to assign a risk score to the user account;
determining that the risk score is greater than a threshold risk score;
adding the user account to a watchlist database for fraud detection;
calculating a number of infractions for the added user account and, where the number of infractions is greater than a selected infraction threshold, marking the deposit for further review,
wherein calculating the number of infractions includes one or more of analyzing the user account information for a number of authentication infractions, analyzing user deposit records for suspicious activity, analyzing disbursement records for suspicious activity, analyzing user account for suspicious activity, analyzing user deposit records for deposits in bad order, and importing one or more third-party fraud risk scores.

17. The system of claim 16, wherein the server computing device is further operable to alter a number of processing threads used for evaluating the user account information or calculating the number of infractions based on one or more of a number of new use accounts to evaluate and a total number of user accounts in the watchlist database.

18. The system of claim 16, wherein the calculating step is automatically repeated periodically for each user account in the watchlist database.

19. The system of claim 18, further comprising removing the user account from the watchlist database where the number of infractions for the added user account is below a monitoring threshold.

20. The system of claim 16, wherein the server computing device is further operable to remove the user account from the watchlist database after a selected period of user inactivity.
